(19) United States
(12) Patent Application Publication
(10) Pub. No.: US 2024/0103817 A1
(43) Pub. Date: Mar. 28, 2024

(54) BEHAVIOR TREE-BASED SCRIPT GENERATION AND RECOMMENDATION

(71) Applicant: INTERNATIONAL BUSINESS MACHINES CORPORATION, ARMONK, NY (US)

(72) Inventors: Jing Zhao, Beijing (CN); Xiao Yun Wang, Beijing (CN); Si Yu Chen, Beijing (CN); Jiang Yi Liu, Beijing (CN); Jiangang Deng, Beijing (CN)

(21) Appl. No.: 17/934,719

(22) Filed: Sep. 23, 2022

(51) Int. Cl. G06F 8/36; G06F 8/41

(52) U.S. Cl. CPC G06F 8/36; G06F 8/427

(57) ABSTRACT

A method, system, and computer program product for script generation and recommendation from behavior trees are provided. The method receives a set of input commands within a programming interface. The set of input commands is parsed into a set of command parts. The set of input commands is normalized based on the set of command parts to generate a set of normalized commands. A set of behavior trees are generated based on the set of normalized commands and the set of parts. The method generates a set of command scripts based on the set of behavior trees.

### BACKGROUND

Programmers and users often enter sets of commands in computing systems to achieve desired functions. Individuals often attempt to automate or partially automate routine or repeated sets of commands by writing scripts. A script often acts as a batch command, such that entry or selection of a script executes a set of commands. Some systems exist to automate generation of scripts based on user history of repeated commands or recording specific commands to be repeated in a defined sequence.

### SUMMARY

According to an embodiment described herein, a computer-implemented method for script generation and recommendation from behavior trees is provided. The method receives a set of input commands within a programming interface. The set of input commands is parsed into a set of command parts. The set of input commands is normalized based on the set of command parts to generate a set of normalized commands. A set of behavior trees are generated based on the set of normalized commands and the set of parts. The method generates a set of command scripts based on the set of behavior trees.

According to an embodiment described herein, a system for script generation and recommendation from behavior trees is provided. The system includes one or more processors and a computer-readable storage medium, coupled to the one or more processors, storing program instructions that, when executed by the one or more processors, cause the one or more processors to perform operations. The operations receive a set of input commands within a programming interface. The set of input commands is parsed into a set of command parts. The set of input commands is normalized based on the set of command parts to generate a set of normalized commands. A set of behavior trees are generated based on the set of normalized commands and the set of parts. The operations generate a set of command scripts based on the set of behavior trees.

According to an embodiment described herein, a computer program product for script generation and recommendation from behavior trees is provided. The computer program product includes a computer-readable storage medium having program instructions embodied therewith, the program instructions being executable by one or more processors to cause the one or more processors to receive a set of input commands within a programming interface. The set of input commands is parsed into a set of command parts. The set of input commands is normalized based on the set of command parts to generate a set of normalized commands. A set of behavior trees are generated based on the set of normalized commands and the set of parts. The computer program product generates a set of command scripts based on the set of behavior trees.

### BRIEF DESCRIPTION OF THE DRAWINGS

FIG. 1 depicts a block diagram of a computing environment for implementing concepts and computer-based methods, according to at least one embodiment.

FIG. 2 depicts a flow diagram of a computer-implemented method for script generation from behavior trees, according to at least one embodiment.

FIG. 3 depicts a block diagram of a behavior tree, according to at least one embodiment.

FIG. 4 depicts a flow diagram of a computer-implemented method for script generation and recommendation from behavior trees, according to at least one embodiment.

FIG. 5 depicts a schematic diagram of a computing environment for executing program code related to the methods disclosed script generation and recommendation from behavior trees, according to at least one embodiment.

### DETAILED DESCRIPTION

The present disclosure relates generally to methods for script generation from behavior trees. More particularly, but not exclusively, embodiments of the present disclosure relate to a computer-implemented method for script generation and recommendation from behavior trees generated from user input commands. The present disclosure relates further to a related system for script generation from behavior trees, and a computer program product for operating such a system.

Programmers and users often enter sets of commands in computing systems repeatedly to achieve desired functions and attempt to automate or partially automate repeated sets of commands by writing scripts. In daily work, uncomplicated commands and commands with low repetition rates often escape automation due to a low return on the automation investment effort. Current systems generate scripts that fail to filter out trivial commands. For example, commands such as “ls” and “pwd” are often included in scripts generated automatically. Scripts which include trivial commands are not concise and may cause issues including increased computing overhead. Similarly, current automation functions often fail to provide an ability to modify the automation process or a script resulting from that process. In these systems, if a user needs to modify a given script, that user must spend additional time, effort, and computing cycles to analyze and modify the generated scripts. Further, current automation systems do not provide a simple and robust manner to present a logical idea of a command.

The present disclosure provides methods and systems to intelligently generate scripts. Embodiments of the present disclosure construct user behavior trees from input commands to intelligently generate scripts. Some embodiments of the present disclosure enable modification of scripts and operations for the generation of those scripts. The present disclosure enables users to modify behavior trees and set variables according to needs or desires of the user. Embodiments of the present disclosure generate and present script recommendations to users. Such embodiments match user input commands and behavior trees to facilitate generation and recommendation of scripts.

Some embodiments of the concepts described herein may take the form of a system or a computer program product. For example, a computer program product may store program instructions that, when executed by one or more processors of a computing system, cause the computing system to perform operations described above with respect to the computer-implemented method. By way of further example, the system may comprise components, such as processors and computer-readable storage media. The computer-readable storage media may interact with other components of the system to cause the system to execute program instructions comprising operations of the computer-implemented method, described herein. For the purpose of this description, a computer-usable or computer-readable medium may be any apparatus that may contain means for storing, communicating, propagating, or transporting the program for use, by, or in connection with, the instruction execution system, apparatus, or device.

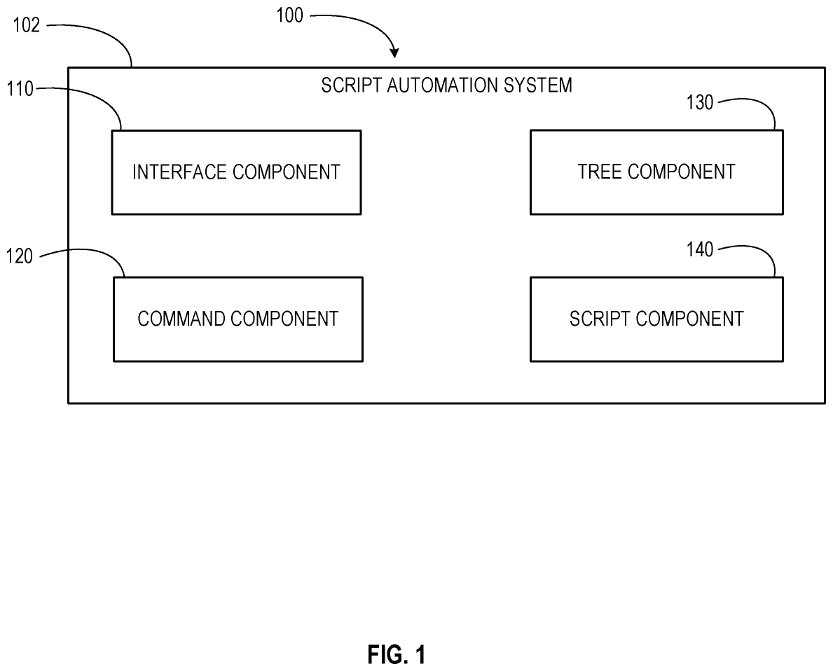

Referring now to FIG. 1, a block diagram of an example computing environment 100 is shown. The present disclosure may be implemented within the example computing environment 100. In some embodiments, the computing environment 100 may be included within or embodied by a computer system, described below. The computing environment 100 may include a script automation system 102. The script automation system 102 may comprise an interface component 110, a command component 120, a tree component 130, and script component 140. The interface component 110 receives and identifies input commands generated or entered by a user. The command component 120 processes input commands of users. The tree component 130 generates behavior trees and matches portions of processed input commands with portions of existing behavior trees. The script component 140 generates and recommends scripts for presentation to users. Although described with distinct components, it should be understood that, in at least some embodiments, components may be combined or divided, and/or additional components may be added without departing from the scope of the present disclosure.

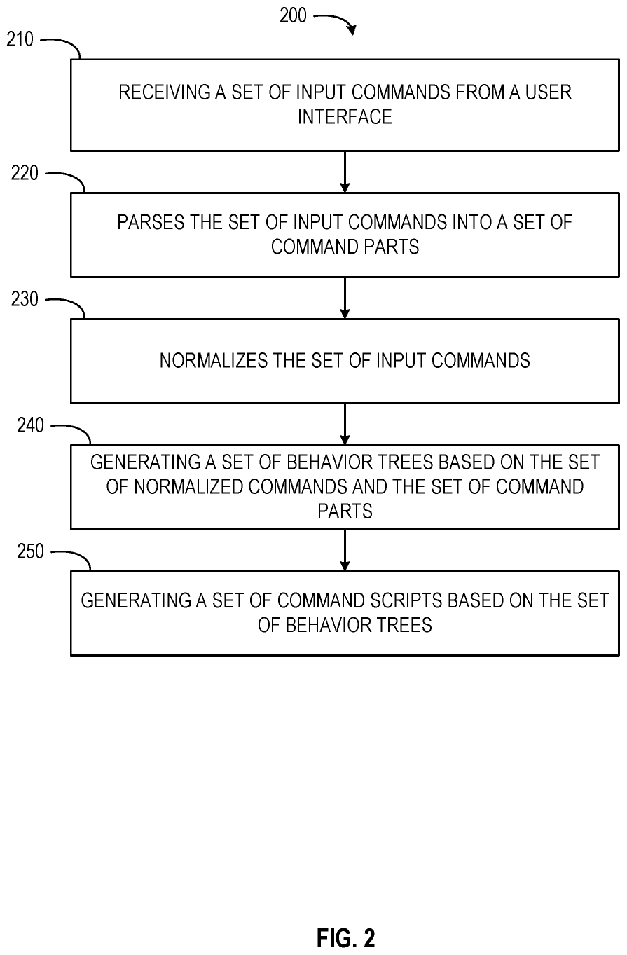

Referring now to FIG. 2, a flow diagram of a computer-implemented method 200 is shown. The computer-implemented method 200 is a method for script generation from behavior trees. In some embodiments, the computer-implemented method 200 may be performed by one or more components of the computing environment 100, as described in more detail below.

At operation 210, the interface component 110 receives a set of input commands. The set of input commands may be received in a user interface of a programming interface. In some embodiments, the interface component 110 receives the set of input commands after the user selects a start indicator within the user interface. Selection of the start indicator indicates a beginning of a recording for input commands for a behavior process. The behavior process may be represented by a behavior tree, to be generated by the script automation system 102. If the user does not input any content within a set time (e.g., during a recording process), the interface component 110 generates a user request to determine whether to continue recording. In some embodiments, until the user confirms that the recording has ended, the interface component 110 may continue the recording session. Once the input commands for a behavior record have been entered, the user may select an end identifier. The end identifier may be a user interface element triggering the interface component 110 to end the recording.

At operation 220, the command component 120 parses the set of input commands. In some embodiments, the set of input commands are parsed into a set of command parts. The command component 120 may parse the set of input commands into four command parts. The command parts may include user, location, options, and argument. The user command part may refer to users having different login credentials. The login credentials may be associated with one or more computing systems or resources accessible to, or associated with, the script automation system 102. The location command part may include a server. The location of the server may include a location of a cloud server, a host, or any other suitable and associated computing resource. In some instances, the location command part includes an absolute path of a specific operation of the input command. The option command part may include options and parameters of that option. The argument command part may refer to a specific object of an operation of the input command. For example, a command may be written as “[root@localhost—]#cp-r test/newtest”. In the example, “root” may be identified as the user, “localhost—” may be identified as the location, “cp-r” may be identified as the option, and “test/newtest” may be identified as an argument.

At operation 230, the command component 120 normalizes the set of input commands. In some embodiments, the set of input commands are normalized based on the set of command parts. Normalizing the set of input commands generates a set of normalized commands.

In some embodiments, the command component 120 normalizes the set of input commands by completing options contained within the set of input commands. Options with no parameters are counted as null. For example, a command of “root@svtserver3 ˜/INC >exit” may have a null argument value as the option “exit” contains no parameter. The command component 120 arranges the parameters of the options in alphabetical order. The command component 120 may then check system alias settings and restore input commands to an original name if an alias is determined to exist for the input command. In some embodiments, the command component 120 disassembles input commands into the smallest unit of the input command. The command component 120 may disassemble commands which are determined to be complex or associated with continuous command processing. For example, a command of “root@ svtserver3 ˜/INC >echo ‘Email Content: This is the content of mail.’ mail-s ‘Email Subject: This is the subject of mail’ firstname.lastname@INC.com” may be disassembled into three commands separated for the email content, the email subject, and the sender address.

At operation 240, the tree component 130 generates a set of behavior trees. Behavior trees may be generated based on a user's input history after the start indicator has been initiated and the input commands recorded in operation 210. In some embodiments, the set of behavior trees are generated based on the set of normalized commands. In some instances, the set of behavior trees are generated based on the set of command parts. The set of behavior trees may also be generated based on a combination of the set of normalized commands and the set of command parts. The tree component 130 may generate a tree branch of a behavior tree based on changes in one or more command parts. For example, the tree component 130 may generate a tree branch in a behavior tree based on switching a location or a user in the set of command parts.

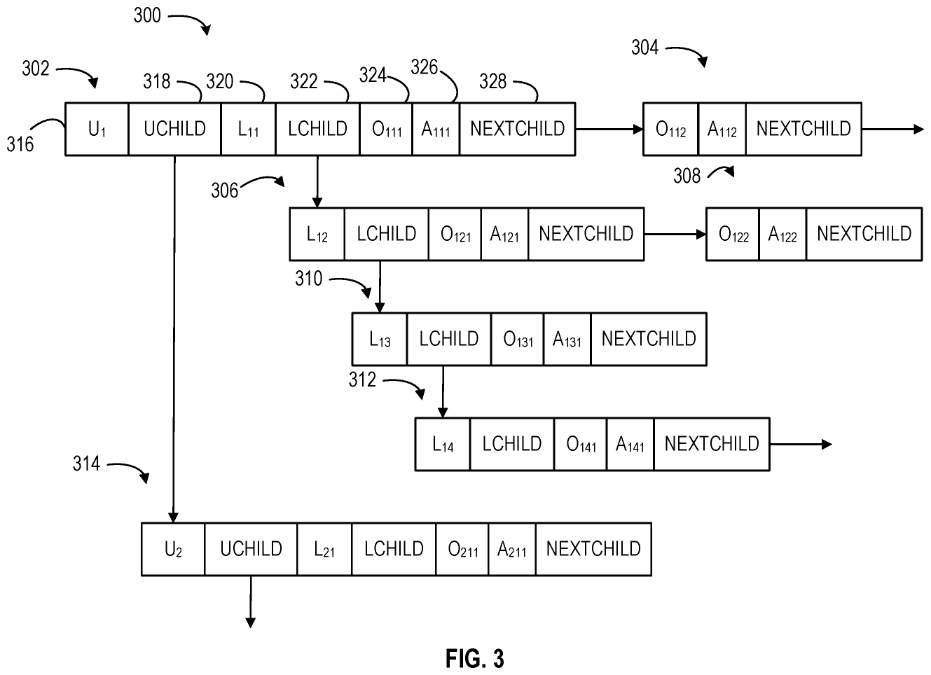

Each behavior tree of the set of behavior trees may be generated as a linked list. As shown in FIG. 3, a behavior tree 300 may be comprised of a plurality of linked lists 302-314. Each linked list 302-314 may be generated from the set of normalized commands and the set of command parts. In some instances, seven domains may be included in the linked lists. For example, a linked list of a behavior tree may include domains of U, uchild, L, lchild, 0, A, and nextchild. U may be a domain for a user identification, such as U₁ 316 in FIG. 3. The uchild domain may include a pointer to a behavior of a next user, such as uchild 318 in FIG. 3. The L domain may be associated with location, such as L₁₁ 320 in FIG. 3. The lchild domain may include a pointer for to record a behavior of the same user under different operation paths, such as 1child 322 in FIG. 3. The 0 domain may be associated with an option of an input command, such as O₁₁₁ 324 in FIG. 3. The A domain may be associated with an argument of an input command, such as A₁₁₁ 326 in FIG. 3. The nextchild domain may include a pointer to record a behavior of the same user under the same path, such as nextchild 328 in FIG. 3.

When a user operates under a same path, the nextchild pointer points to a next node. For example, a user operating in a same path between nodes is shown at the junction between linked lists 302 and 304 and the junction between linked lists 306 and 308. The next node (e.g., linked list 304) in the behavior tree (e.g., behavior tree 300) may only record options, argument, and the nextchild pointer for the node of the input commands. When a user switches to another path to perform operations, the lchild pointer may point to a next node. For example, a user switching paths is shown at the junction between linked lists 302 and 306, linked lists 306 and 310, and linked lists 310 and 312. The next node (e.g., linked list 306) in the behavior tree (e.g., behavior tree 300) may record domains for location, lchild, options, argument, and the nextchild pointer of the node. In instances of a user switching to another account to perform operations, the uchild pointer points to the next node. For example, a user switching accounts is shown at the junction between linked lists 302 and 314. That next node (e.g., linked list 314) of the behavior tree (e.g., behavior tree 300) may record user, uchild, location, lchild, options, argument, and the nextchild pointer of the node.

At operation 250, the script component 140 generates a set of command scripts. In some embodiments, the set of command scripts are generated based on the set of behavior trees. The script component 140 may directly generate the set of command scripts from the set of behavior trees. In some embodiments, a command script may be generated for each behavior tree of the set of behavior trees. The script component 140 may also generate a plurality of command scripts for each behavior tree. For example, a command script may be generated for each branch of a behavior tree.

In some embodiments, the script component 140 performs a set of operations to generate, or prior to generating, the set of command scripts. In such instances, the script component 140 prunes a subset of command nodes from the set of behavior trees. In pruning a command node, the script component 140 may remove a command node deemed unnecessary or trivial from the command nodes used to generate the set of command scripts. For example, unnecessary or trivial commands may be is or pwd commands. In some instances, a user designates commands or nodes to be removed. The user may designate the commands or nodes by typing a representation of the command in a user interface or selecting the command from a set of user interface elements generated to represent command nodes within the behavior tree. In some embodiments, the script component 140 may selectively remove or prune the subset of command nodes without user input. In such instances, the script component 140 may remove the unnecessary or trivial command nodes based on one or more characteristics of the command nodes, rules established for designating unnecessary or trivial commands, frequency of occurrence or length of the command nodes, combinations thereof, or any other suitable determination process. Once pruned, the command nodes may be stored in a trivial command library. The trivial command library may correspond or be associated with a behavior tree from which the command nodes saved therein were removed. The pruned command nodes, stored in the trivial command library, may include five domains. The five domains may include domains for a user, a location, an option, an argument, and a nextchild. In some instances, commands removed to the trivial command library are removed from consideration for matching and recommendation as command scripts.

In some embodiments, the script component 140 merges consecutive steps within the set of behavior trees. The user may designate steps to be combined. In some instances, the script component 140 merges consecutive steps based on the content of the consecutive steps. The script component 140 may save merged continuous command nodes to the trivial command library corresponding to the behavior tree from which the command nodes were merged.

The script component 140 may then identify variables within the set of normalized commands and the set of command parts. In some embodiments, the script component 140 identifies variables within nodes and fields of the behavior tree. The script component 140 may also determine which part of a string in a field is a variable. In some instances, an entire field may be specified as a variable. Some or all fields in a domain may be identified as variables. All fields except pointers could specify variables. The user may also identify or designate variables within the command nodes of a behavior tree. In some instances, where no variables are specified, all arguments may be identified as variables by the script component 140.

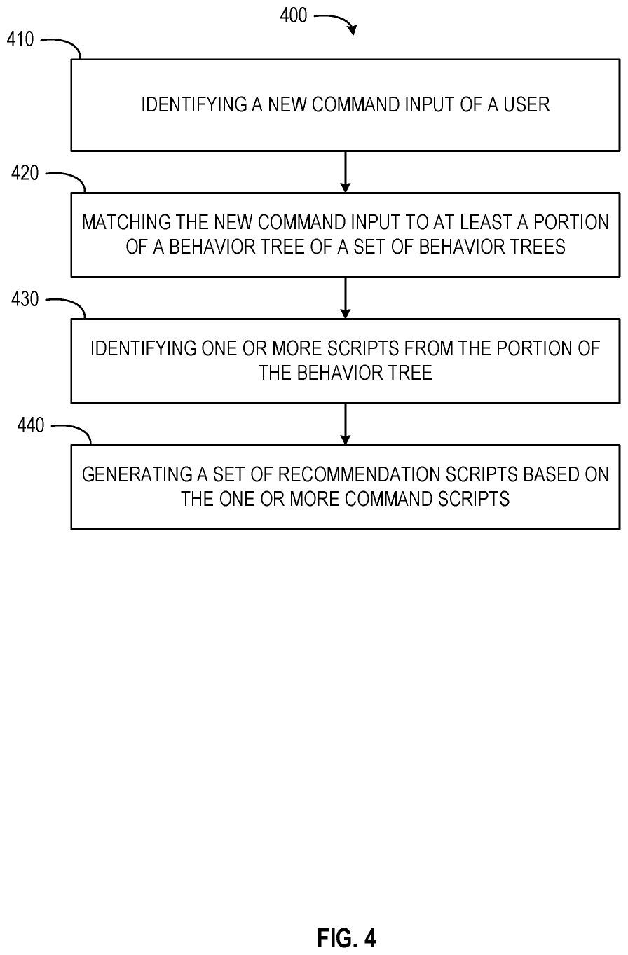

FIG. 4 shows a flow diagram of an embodiment of a computer-implemented method 400 for script generation and recommendation from behavior trees. The method 400 may be performed by or within the computing environment 100. In some embodiments, the method 400 comprises or incorporates one or more operations of the method 200. In some instances, operations of the method 400 may be incorporated as part of or sub-operations of the method 200.

In operation 410, the command component 120 identifies a new command input of a user. In some embodiments, the new command input represents at least a portion of code generated by the user. The new command may be received by the command component 120 after a set of behavior trees have been generated.

In operation 420, the tree component 130 matches the new command input of the user to at least a portion of a behavior tree of the set of behavior trees. The tree component 130 may match the new command input to the portion of the behavior tree by comparing portions of the new command input with command nodes stored within the behavior tree. In some embodiments, the tree component 130 cooperates with the command component 120 to match the new command input. In such instances, the command component 120 may parse the new command input into command parts. The tree component 130 may progressively compare the command parts of the new command input with portions of the behavior tree to determine a match.

In some embodiments, the tree component 130 matches the new command input by identifying one or more command parts as one or more command nodes within the new command input. In such embodiments, the tree component 130 identifies command parts such as user, location, option, and argument domains.

The tree component 130 may then compare the one or more command nodes with a set of tree nodes of the behavior tree. The tree component 130 may compare the one or more command nodes and tree nodes by comparing variables within the command nodes or command parts. Where no variables occur within a command part or domain, the tree component 130 may proceed to a next command part or domain.

In some embodiments, the tree component 130 matches the new command input by identifying a subset of behavior trees matching a portion of the new command input. For example, where the tree component 130 identifies user domains within the new command input, the tree component 130 may determine a character string of user is specified as a variable. The tree component 130 may match all characters except the variable and use an exact match between the part or command node and the tree node. Once the characters are matched, the tree component 130 may proceed to a next domain or command part. If part of a character string of user is not specified as a variable, the tree component 130 may record the instance and not identify a match.

Where the tree component 130 identifies a location domain, the tree component 130 may attempt to match a string designated by the location domain. If the string is similar, the tree component 130 may continue to an options command part of the new command and the behavior tree. If part of a location string is specified as a variable, the tree component 130 may match all characters except the variable. The tree component 130 may exactly match the characters. If a match does not occur, the tree component may cease matching the command within the behavior tree and continue to a next input command.

Where the tree component 130 identifies an option domain, the tree component 130 may attempt to match a string or part of a string designated by the option domain. If part of a string of an option domain is designated as a variable, all characters except the variable may be matched. In such instances, an exact match may be used. If a portion of an option string is not specified as a variable, an exact match may be used.

Where the tree component 130 identifies an argument domain, the tree component 130 may attempt to match a string or part of a string designated by the argument domain. If part of the argument string is specified as a variable, all characters within the string except the variable may be matched using an exact match strategy. If part of the argument string is not specified as a variable, the instance may be recorded and no more matching may be performed.

In some embodiments, if a first command is matched, when a new or subsequent command is entered again, the match may be initiated from a next node pointed to by the matched node pointer within the behavior tree. The tree component 130 may first horizontally compare all nodes composed of options and arguments pointed to by a nextchild domain of the same user and location. The tree component 130 may compare all nodes composed of location, options, and argument pointed to by the lchild node of the same user once comparison proceeds in a vertical direction (e.g., after a horizontal comparison is concluded). The tree component 130 may perform horizontal and vertical comparisons in a similar or same manner. If a next command does not match, after matching the first command, the tree component 130 may identify a match within the trivial command library associated with the behavior tree.

The tree component 130 may match the five domains within the trivial command library in sequence, in a manner similar to or the same as described above. If the tree component 130 matches a previous single command, the tree component may ignore the command and continue to match a next input command, otherwise the match may fail. If the tree component 130 matches a previous set of consecutive commands with pointers, the consecutive input commands need to be matched or the match fails.

The tree component 130 may include the subset of behavior trees for inclusion in a first matching list. When a user enters a new command input, the tree component 130 automatically matches at least one existing behavior tree, if at least one behavior tree is a suitable match for the new command input. In some embodiments, the match, identified within a behavior tree, may be any node in the behavior tree. Once a match has been identified, the behavior tree is placed into the first matching list. If no matching nodes are identified, the new command input may be discarded for matching.

The tree component 130 may then selectively remove one or more behavior trees of the subset of behavior trees from the matching list. The one or more behavior trees may be removed for failing to match at least a portion of a subsequent new command input. In some instances, removal of the one or more behavior trees generates a second matching list.

For example, after successfully matching a first new command input, the tree component 130 may attempt to match a second new command input. The tree component 130 may attempt to match the second or next new command input at a behavior tree in the first matching list. The first match list may include all nodes of the behavior trees included in the first match list. The tree component 130 may begin matching from a command node at which the previous new command input was matched. The tree component 130 may attempt to match the second new command input in a manner similar to or the same as performed for the first new command input starting from a node match of the first new command input. Where the node or other nodes on the behavior tree match the second new command input, that behavior tree is maintained in the first matching list. The tree component 130 may repeat this process with additional new command inputs or additional elements being added to a new command input. Where the node or other nodes on the behavior tree fail to match the second new command input, that behavior tree is removed from the first matching list to create the second or subsequent matching list.

In some embodiments, where a subsequent or second new command input does not match a node in a behavior tree, the tree component 130 may compare the subsequent new command input to a trivial command library for that behavior tree. The tree component 130 may also compare the subsequent new command input to the trivial command library of all behavior trees in the matching list. The tree component 130 sequentially or successively compares the subsequent new command input to each trivial command library until a match is found or the trivial command libraries have been exhausted. If the subsequent new command input matches with the trivial command library of the behavior tree matching the first new command input, that behavior tree is maintained in the matching list and a next matching may be performed. In some embodiments, if the trivial command library is matched a match between the command input and the behavior tree is ignored and a next command analyzed for matching.

In operation 430, the script component 140 identifies one or more scripts from the portion of the behavior tree. The script component 140 may identify the one or more scripts as scripts generated from the behavior trees matching the new command input or new command inputs. In some instances, the script component 140 may generate one or more scripts for behavior trees identified as matching the new command input or new command inputs.

In operation 440, the script component 140 generates a set of recommended scripts based on the set of command scripts. In some embodiments, the set of recommended scripts are generated based on the set of recommended scripts and the portion of the behavior tree. In some embodiments, the tree component 130 and the script component 140 match new command inputs, or portions thereof, to at least a portion of a behavior tree. The tree component 130 and script component 140 may generate the set of recommended scripts by running several related commands of the new command inputs in succession. The script component 140 may generate the set of recommended scripts while ignoring trivial commands.

In some embodiments, when a plurality of new command inputs have been matched, the script component 140 recommends the behavior trees in the matching list or related scripts to the user in the set of recommended scripts. The set of recommended scripts may be accompanied by a recommendation interface. The recommendation interface may include interface elements, the selection of which enables the user to delete one or more suggested scripts. When a single behavior tree remains in the matching list, the script component 140 generates the set of recommended scripts based on the remaining behavior tree or selects one or more scripts generated from the remaining behavior tree. The script or scripts of the remaining behavior tree may be recommended to the user, with the recommendation interface containing interface elements enabling the script to be chosen and executed. In some instances, selection of an interface element enables execution of all or a portion of the selected script. In some embodiments, where the matching list is empty, the matching process fails and no scripts are populated in the set of recommended scripts.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

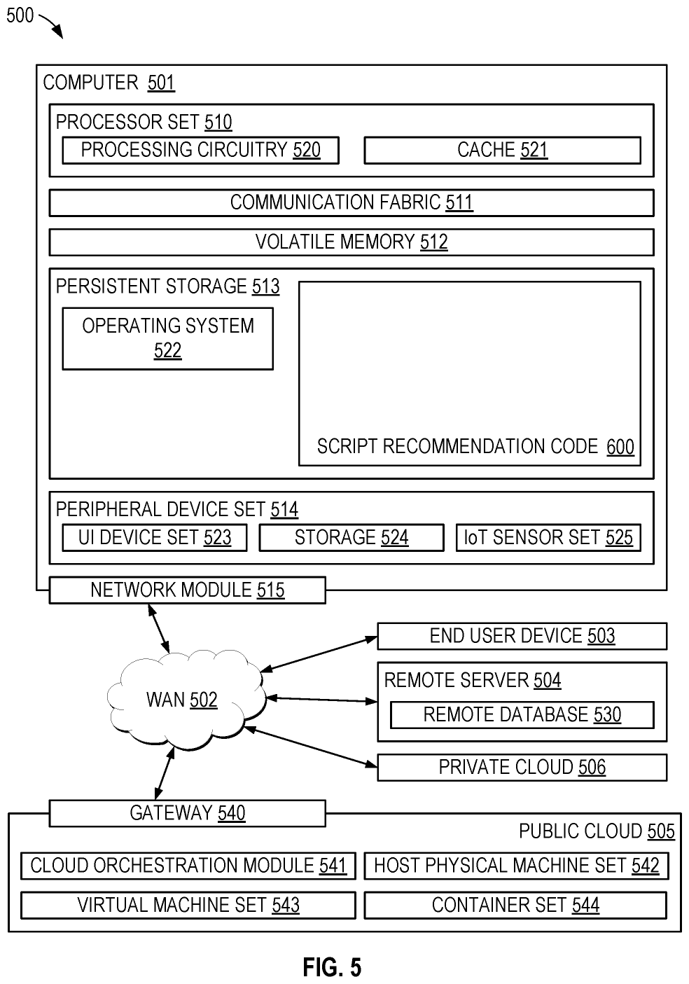

Embodiments of the present disclosure may be implemented together with virtually any type of computer, regardless of the platform is suitable for storing and/or executing program code. FIG. 5 shows, as an example, a computing environment 500 (e.g., cloud computing system) suitable for executing program code related to the methods disclosed herein and for script generation and recommendation from behavior trees. In some embodiments, the computing environment 500 may be the same as or an implementation of the computing environment 100.

Computing environment 500 contains an example of an environment for the execution of at least some of the computer code involved in performing the inventive methods, such as script recommendation code 600. The script recommendation code 600 may be a code-based implementation of the script automation system 102. In addition to script recommendation code 600, computing environment 500 includes, for example, a computer 501, a wide area network (WAN) 502, an end user device (EUD) 503, a remote server 504, a public cloud 505, and a private cloud 506. In this embodiment, the computer 501 includes a processor set 510 (including processing circuitry 520 and a cache 521), a communication fabric 511, a volatile memory 512, a persistent storage 513 (including operating a system 522 and the script recommendation code 600, as identified above), a peripheral device set 514 (including a user interface (UI) device set 523, storage 524, and an Internet of Things (IoT) sensor set 525), and a network module 515. The remote server 504 includes a remote database 530. The public cloud 505 includes a gateway 540, a cloud orchestration module 541, a host physical machine set 542, a virtual machine set 543, and a container set 544.

The computer 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 530. As is well understood in the art of computer technology, and depending upon the technology, performance of a computer-implemented method may be distributed among multiple computers and/or between multiple locations. On the other hand, in this presentation of the computing environment 500, detailed discussion is focused on a single computer, specifically the computer 501, to keep the presentation as simple as possible. The computer 501 may be located in a cloud, even though it is not shown in a cloud in FIG. 5. On the other hand, the computer 501 is not required to be in a cloud except to any extent as may be affirmatively indicated.

The processor set 510 includes one, or more, computer processors of any type now known or to be developed in the future. The processing circuitry 520 may be distributed over multiple packages, for example, multiple, coordinated integrated circuit chips. The processing circuitry 520 may implement multiple processor threads and/or multiple processor cores. The cache 521 is memory that is located in the processor chip package(s) and is typically used for data or code that should be available for rapid access by the threads or cores running on the processor set 510. Cache memories are typically organized into multiple levels depending upon relative proximity to the processing circuitry. Alternatively, some, or all, of the cache for the processor set may be located “off chip.” In some computing environments, the processor set 510 may be designed for working with qubits and performing quantum computing.

Computer readable program instructions are typically loaded onto the computer 501 to cause a series of operational steps to be performed by the processor set 510 of the computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as the cache 521 and the other storage media discussed below. The program instructions, and associated data, are accessed by the processor set 510 to control and direct performance of the inventive methods. In the computing environment 500, at least some of the instructions for performing the inventive methods may be stored in the script recommendation code 600 in the persistent storage 513.

The communication fabric 511 is the signal conduction path that allows the various components of the computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

The volatile memory 512 is any type of volatile memory now known or to be developed in the future. Examples include dynamic type random access memory (RAM) or static type RAM. Typically, the volatile memory 512 is characterized by random access, but this is not required unless affirmatively indicated. In the computer 501, the volatile memory 512 is located in a single package and is internal to the computer 501, but, alternatively or additionally, the volatile memory may be distributed over multiple packages and/or located externally with respect to the computer 501.

The persistent storage 513 is any form of non-volatile storage for computers that is now known or to be developed in the future. The non-volatility of this storage means that the stored data is maintained regardless of whether power is being supplied to the computer 501 and/or directly to the persistent storage 513. The persistent storage 513 may be a read only memory (ROM), but typically at least a portion of the persistent storage allows writing of data, deletion of data and re-writing of data. Some familiar forms of persistent storage include magnetic disks and solid-state storage devices. The operating system 522 may take several forms, such as various known proprietary operating systems or open-source Portable Operating System Interface-type operating systems that employ a kernel. The code included in the script recommendation code 600 typically includes at least some of the computer code involved in performing the inventive methods.

The peripheral device set 514 includes the set of peripheral devices of the computer 501. Data communication connections between the peripheral devices and the other components of the computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 523 may include components such as a display screen, speaker, microphone, wearable devices (such as goggles and smart watches), keyboard, mouse, printer, touchpad, game controllers, and haptic devices. The storage 524 is external storage, such as an external hard drive, or insertable storage, such as an SD card. The storage 524 may be persistent and/or volatile. In some embodiments, the storage 524 may take the form of a quantum computing storage device for storing data in the form of qubits. In embodiments where the computer 501 is required to have a large amount of storage (for example, where the computer 501 locally stores and manages a large database) then this storage may be provided by peripheral storage devices designed for storing very large amounts of data, such as a storage area network (SAN) that is shared by multiple, geographically distributed computers. The IoT sensor set 525 is made up of sensors that can be used in Internet of Things applications. For example, one sensor may be a thermometer and another sensor may be a motion detector.

The network module 515 is the collection of computer software, hardware, and firmware that allows the computer 501 to communicate with other computers through the WAN 502. The network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 515 are performed on the same physical hardware device. In other embodiments (for example, embodiments that utilize software-defined networking (SDN)), the control functions and the forwarding functions of the network module 515 are performed on physically separate devices, such that the control functions manage several different network hardware devices. Computer readable program instructions for performing the inventive methods can typically be downloaded to the computer 501 from an external computer or external storage device through a network adapter card or network interface included in the network module 515.

The WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

The end user device (EUD) 503 is any computer system that is used and controlled by an end user (for example, a customer of an enterprise that operates the computer 501), and may take any of the forms discussed above in connection with the computer 501. The EUD 503 typically receives helpful and useful data from the operations of the computer 501. For example, in a hypothetical case where the computer 501 is designed to provide a recommendation to an end user, this recommendation would typically be communicated from the network module 515 of the computer 501 through the WAN 502 to the EUD 503. In this way, the EUD 503 can display, or otherwise present, the recommendation to an end user. In some embodiments, the EUD 503 may be a client device, such as thin client, heavy client, mainframe computer, desktop computer and so on.

The remote server 504 is any computer system that serves at least some data and/or functionality to the computer 501. The remote server 504 may be controlled and used by the same entity that operates computer 501. The remote server 504 represents the machine(s) that collect and store helpful and useful data for use by other computers, such as the computer 501. For example, in a hypothetical case where the computer 501 is designed and programmed to provide a recommendation based on historical data, then this historical data may be provided to the computer 501 from the remote database 530 of the remote server 504.

The public cloud 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 505 is performed by the computer hardware and/or software of the cloud orchestration module 541. The computing resources provided by the public cloud 505 are typically implemented by virtual computing environments that run on various computers making up the computers of the host physical machine set 542, which is the universe of physical computers in and/or available to the public cloud 505. The virtual computing environments (VCEs) typically take the form of virtual machines from the virtual machine set 543 and/or containers from the container set 544. It is understood that these VCEs may be stored as images and may be transferred among and between the various physical machine hosts, either as images or after instantiation of the VCE. The cloud orchestration module 541 manages the transfer and storage of images, deploys new instantiations of VCEs and manages active instantiations of VCE deployments. The gateway 540 is the collection of computer software, hardware, and firmware that allows the public cloud 505 to communicate through the WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 506 is similar to the public cloud 505, except that the computing resources are only available for use by a single enterprise. While the private cloud 506 is depicted as being in communication with the WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 505 and the private cloud 506 are both part of a larger hybrid cloud.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

In some embodiments, one or more of the operating system 522 and the script recommendation code 600 may be implemented as service models. The service models may include software as a service (SaaS), platform as a service (PaaS), and infrastructure as a service (IaaS). In SaaS, the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings. In PaaS, the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. In IaaS, the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatuses, or another device to cause a series of operational steps to be performed on the computer, other programmable apparatus or other device to produce a computer implemented process, such that the instructions which execute on the computer, other programmable apparatuses, or another device implement the functions/acts specified in the flowchart and/or block diagram block or blocks.

The flowcharts and/or block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or act or carry out combinations of special purpose hardware and computer instructions.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will further be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present disclosure has been presented for purposes of illustration and description, but is not intended to be exhaustive or limited to the present disclosure in the form disclosed. Many modifications and variations will be apparent to those of ordinary skills in the art without departing from the scope of the present disclosure. The embodiments are chosen and described in order to explain the principles of the present disclosure and the practical application, and to enable others of ordinary skills in the art to understand the present disclosure for various embodiments with various modifications, as are suited to the particular use contemplated.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving a set of input commands within a programming interface;
parsing the set of input commands into a set of command parts;
normalizing the set of input commands based on the set of command parts to generate a set of normalized commands;
generating a set of behavior trees based on the set of normalized commands and the set of command parts; and
generating a set of command scripts based on the set of behavior trees.

2. The method of claim 1, wherein generating the set of behavior trees further comprises:
generating a linked list from the set of normalized commands and the set of command parts.

3. The method of claim 1, wherein generating the set of command scripts further comprises:
pruning a subset of command nodes from the set of behavior trees;
merging consecutive steps within the set of behavior trees; and
identifying variables within the set of normalized commands and the set of command parts.

4. The method of claim 1, wherein the method further comprises:
generating a set of recommended scripts based on the set of command scripts.

5. The method of claim 4, wherein the method further comprises:
identifying a new command input of a user, the new command input representing at least a portion of code generated by the user;
matching the new command input of the user to at least a portion of a behavior tree of the set of behavior trees; and
identifying one or more scripts from the portion of the behavior tree as the set of recommended scripts.

6. The method of claim 5, wherein matching the new command input further comprises:
identifying one or more command parts as one or more command nodes within the new command input; and
comparing the one or more command nodes with a set of tree nodes of the behavior tree.

7. The method of claim 5, wherein matching the new command input further comprises:
identifying a subset of behavior trees matching a portion of the new command input;
including the subset of behavior trees for inclusion in a first matching list; and
selectively removing one or more behavior trees of the subset of behavior trees from the matching list for failing to match at least a portion of a subsequent new command input, removal of the one or more behavior trees generating a second matching list.

8. A system, comprising:
one or more processors; and
a computer readable storage medium, coupled to the one or more processors, storing program instructions that, when executed by the one or more processors, cause the one or more processors to perform operations comprising:
receiving a set of input commands within a programming interface;
parsing the set of input commands into a set of command parts;
normalizing the set of input commands based on the set of command parts to generate a set of normalized commands;
generating a set of behavior trees based on the set of normalized commands and the set of command parts; and
generating a set of command scripts based on the set of behavior trees.

9. The system of claim 8, wherein generating the set of behavior trees further comprises:
generating a linked list from the set of normalized commands and the set of command parts.

10. The system of claim 8, wherein generating the set of command scripts further comprises:
pruning a subset of command nodes from the set of behavior trees;
merging consecutive steps within the set of behavior trees; and
identifying variables within the set of normalized commands and the set of command parts.

11. The system of claim 8, wherein the operations further comprise:
generating a set of recommended scripts based on the set of command scripts.

12. The system of claim 11, wherein the operations further comprise:
identifying a new command input of a user, the new command input representing at least a portion of code generated by the user;
matching the new command input of the user to at least a portion of a behavior tree of the set of behavior trees; and
identifying one or more scripts from the portion of the behavior tree as the set of recommended scripts.

13. The system of claim 12, wherein matching the new command input further comprises:
identifying one or more command parts as one or more command nodes within the new command input; and
comparing the one or more command nodes with a set of tree nodes of the behavior tree.

14. The system of claim 12, wherein matching the new command input further comprises:
identifying a subset of behavior trees matching a portion of the new command input;
including the subset of behavior trees for inclusion in a first matching list; and
selectively removing one or more behavior trees of the subset of behavior trees from the matching list for failing to match at least a portion of a subsequent new command input, removal of the one or more behavior trees generating a second matching list.

15. A computer program product comprising a computer readable storage medium having program instructions embodied therewith, the program instructions being executable by one or more processors to cause the one or more processors to perform operations comprising:
receiving a set of input commands within a programming interface;
parsing the set of input commands into a set of command parts;
normalizing the set of input commands based on the set of command parts to generate a set of normalized commands;
generating a set of behavior trees based on the set of normalized commands and the set of command parts; and
generating a set of command scripts based on the set of behavior trees.

16. The computer program product of claim 15, wherein generating the set of command scripts further comprises:
pruning a subset of command nodes from the set of behavior trees;
merging consecutive steps within the set of behavior trees; and
identifying variables within the set of normalized commands and the set of command parts.

17. The computer program product of claim 15, wherein the operations further comprise:
generating a set of recommended scripts based on the set of command scripts.

18. The computer program product of claim 17, wherein the operations further comprise:
identifying a new command input of a user, the new command input representing at least a portion of code generated by the user;
matching the new command input of the user to at least a portion of a behavior tree of the set of behavior trees; and
identifying one or more scripts from the portion of the behavior tree as the set of recommended scripts.

19. The computer program product of claim 18, wherein matching the new command input further comprises:
identifying one or more command parts as one or more command nodes within the new command input; and
comparing the one or more command nodes with a set of tree nodes of the behavior tree.

20. The computer program product of claim 18, wherein matching the new command input further comprises:
identifying a subset of behavior trees matching a portion of the new command input;
including the subset of behavior trees for inclusion in a first matching list; and
selectively removing one or more behavior trees of the subset of behavior trees from the matching list for failing to match at least a portion of a subsequent new command input, removal of the one or more behavior trees generating a second matching list.
